(19) United States
(12) Patent Application Publication
(10) Pub. No.: US 2019/0049722 A1
(43) Pub. Date: Feb. 14, 2019

(54) HEAD-MOUNTED DISPLAY APPARATUS

(71) Applicant: HTC Corporation, Taoyuan City (TW)

(72) Inventors: Qing-Long Deng, Taoyuan City (TW); Yung-Chen Lin, Taoyuan City (TW)

(73) Assignee: HTC Corporation, Taoyuan City (TW)

(21) Appl. No.: 16/045,667

(22) Filed: Jul. 25, 2018

Related U.S. Application Data
(60) Provisional application No. 62/543,392, filed on Aug. 10, 2017.

(51) Int. Cl. G02B 27/00; G06K 9/00

(52) U.S. Cl. CPC G02B 27/0093; G06K 9/00604

(57) ABSTRACT

A head-mounted display apparatus includes a shell and a first light emitter. The shell has an inner surface. The first light emitter is disposed on the shell. The first light emitter transmits a first projection light beam to the inner surface and causes the first projection light beam to bring out at least one reflection action and a scattering action according to the inner surface to generate a first detection light. The first detection light is projected to a first target region. A first projection surface of the first detection light covers a first pre-set area of the first target region.

### CROSS-REFERENCE TO RELATED APPLICATION

This application claims the priority benefit of U.S. provisional application Ser. No. 62/543,392, filed on Aug. 10, 2017. The entirety of the above-mentioned patent application is hereby incorporated by reference herein and made a part of this specification.

### BACKGROUND

### Field of the Disclosure

The invention relates to a head-mounted display apparatus, and specifically relates to a head-mounted display apparatus generating a uniform light surface on the eyeball by indirect lighting.

### Description of Related Art

In the field of conventional technology, an eye tracking process applied to head-mounted display apparatus is usually carried out by pupil center/corneal reflection (PCCR). In this method, the infrared light is used to generate a plurality of bright spots on a cornea, and the bright spots serve as reference points for positioning. The positions of the bright spots are not changed along with rotation of the cornea, so vector between the bright spots and center of the pupil and coordinate of panel image can be used for mapping, so as to calculate an absolute position where the eyeball gazes. Based on the hardware architecture of the abovementioned principle, an infrared camera is needed to capture the positions of the bright spots on the cornea. However, because of the position that the infrared camera is placed, it is easy to capture secondary bright spots or bright spots formed by stray light, so as to cause decrease in accuracy of pupil tracking.

### SUMMARY

The invention provides a head-mounted display apparatus, which is capable of providing a detection light evenly distributed on a target region, so as to reduce the possibility of generating bright spots at the target region.

A head-mounted display apparatus of the invention includes a shell and a first light emitter. The shell has an inner surface. The first light emitter is disposed on the shell. The first light emitter transmits a first projection light beam to the inner surface and causes the first projection light beam to bring out at least one reflection action and a scattering action according to the inner surface to generate a first detection light. The first detection light is projected to the first target region, and the first projection surface of the first detection light covers the first pre-set area of the first target region.

Based on the above description, the light emitter of the invention generates the detection light via making the projection light beam to bring out the at least one reflection action and the scattering action. The detection light is projected to a target region and covers a pre-set area of the target region. As a result, the detection light used for eyeball detection can evenly cover a surface of the eye, so as to reduce the possibility of generating stray light spots.

In order to make the aforementioned features and advantages of the invention more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view depicting a head-mounted display apparatus in an embodiment of the invention.

FIG. 2 is a schematic view depicting a head-mounted display apparatus in another embodiment of the invention.

FIG. 3 is a schematic view depicting a head-mounted display apparatus in another embodiment of the invention.

FIG. 4 is a schematic view depicting a head-mounted display apparatus in another embodiment of the invention.

FIG. 5 is a schematic structural view depicting a head-mounted display apparatus in an embodiment of the invention.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Referring to FIG. 1, which is a schematic view depicting a head-mounted display apparatus in an embodiment of the invention. A head-mounted display apparatus 100 includes a shell 110, a lens device 120, a light emitter 130, and a display 140. The shell 110 has an inner surface IS1. The light emitter 130 is disposed on the shell 110, for example, on the inner surface IS1 of the shell 110. The light emitter 130 is configured to transmit a projection light beam PLB to other parts of the inner surface IS1 of the shell 110, and causes the projection light beam PLB to bring out at least one reflection action and a scattering action according to the inner surface IS1 to generate a detection light DLB.

Via the abovementioned reflection action and scattering action, the detection light DLB is projected to a target region GA1. Based on the abovementioned scattering action, a region area of a projection surface of the detection light DLB increases along with a transmitting distance and covers a pre-set area on the target region GA1.

In the present embodiment, by a method of mechanical design, a location of the target region GA1 may be designed according to a location of eyes of a user. When the head-mounted display apparatus 100 performs, for example, an eyeball tracking process, via the detection light DLB being scattered to the eyes of the user, the evenly-distributed light can be formed on the eyes, so as to reduce the possibility of generating stray bright spots and to improve the accuracy of eyeball tracking process. The pre-set area as mentioned above may be designed according to possible size of the eyes of the user. The pre-set area may be slightly larger than a maximum possible size of the eyes of the user.

Incidentally, in the present embodiment, the lens device 120, the display 140, and the target region GA1 may be disposed along an axis AX1. The target region GA1 and a first side S1 of the lens device 120 are adjacent to each other, and the display 140 and a second side S2 of the lens device 120 are adjacent to each other. A long axis of the lens device 120 may extend along an axis EX1, and the target region GA1 extends along an axis EX2. Besides, the target region GA1 and the display 140 may form a field of view FOV therebetween. It should be noted here, in order to avoid interference of a display image provided by the display 140 which the user views, disposition of the light emitter 130 is avoided to overlap the field of view FOV formed between the target region GA1 and the lens device 120. That is to say, the light emitter 130 may be disposed outside of the field of view FOV.

Moreover, in the present embodiment, the light emitter 130 is disposed on the shell 110 between the lens device 120 and the target region GA1. The projection light beam PLB emitted by the light emitter 130 and the correspondingly-generated detection light DLB may be invisible light beams, such as infrared light beam. The light emitter 130 may be an infrared light emitter.

On the other hand, the inner surface IS1 of the shell 110 may be made of material that reflects and scatters the projection light beam PLB. It is well-known to a person of ordinary skill in the art about materials that reflect and scatter the projection light beam PLB and are applicable to the invention, and there is no special restriction in the invention.

In the present embodiment, the lens device 120 may be constituted by one lens, a plurality of lenses of the same type, or a plurality of lenses of different types, there is no special restriction in the invention. Moreover, the display 140 may be any type of displays that are well-known by a person of ordinary skill in the art without special restriction thereto.

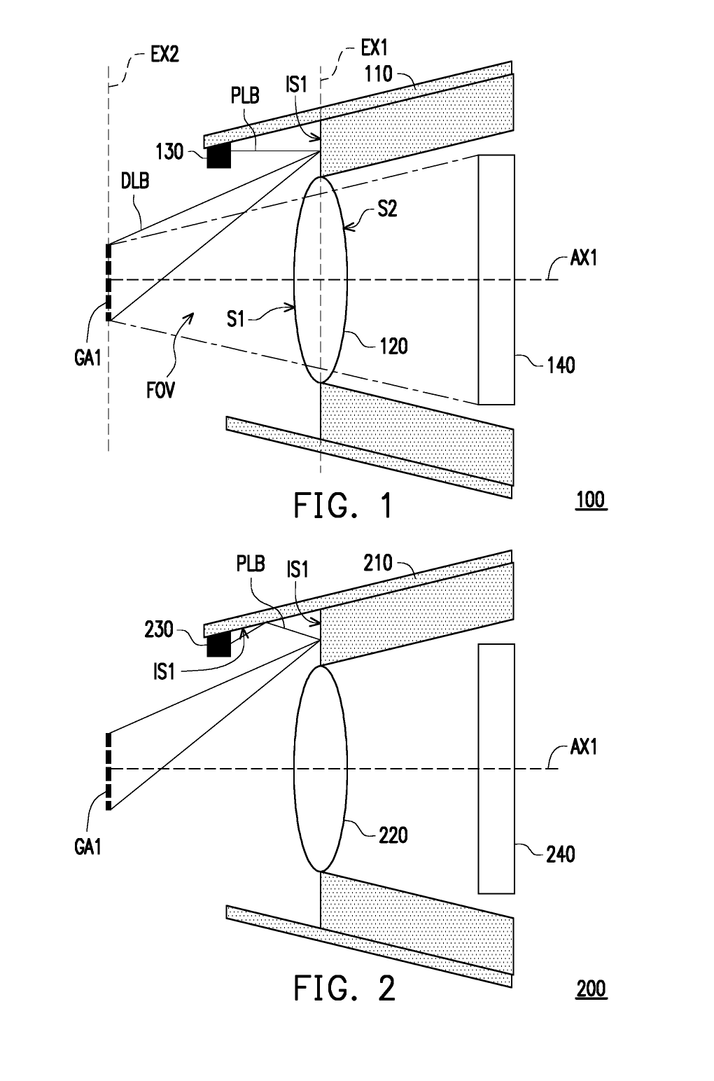

Referring to FIG. 2, which is a schematic view depicting a head-mounted display apparatus in another embodiment of the invention. A head-mounted display apparatus 200 includes a shell 210, a lens device 220, a light emitter 230, and a display 240. The shell 210 has an inner surface IS1. The light emitter 230 is disposed on the shell 210, for example, on the inner surface IS1 of the shell 210. The light emitter 230 is configured to transmit a projection light beam PLB to other parts of the inner surface IS1 of the shell 210, and causes the projection light beam PLB to bring out a plurality times of reflection actions and scattering actions to generate the detection light DLB.

In the present embodiment, the projection light beam PLB generates the detection light DLB via two times of the reflection actions and scattering actions. In other embodiments, the projection light beam PLB can generate the detection light DLB via more than two times of the reflection actions and scattering actions. The number of times of being reflected of the projection light beam PLB is determined according to the disposition of the light emitter 230, and there is no special restriction thereto.

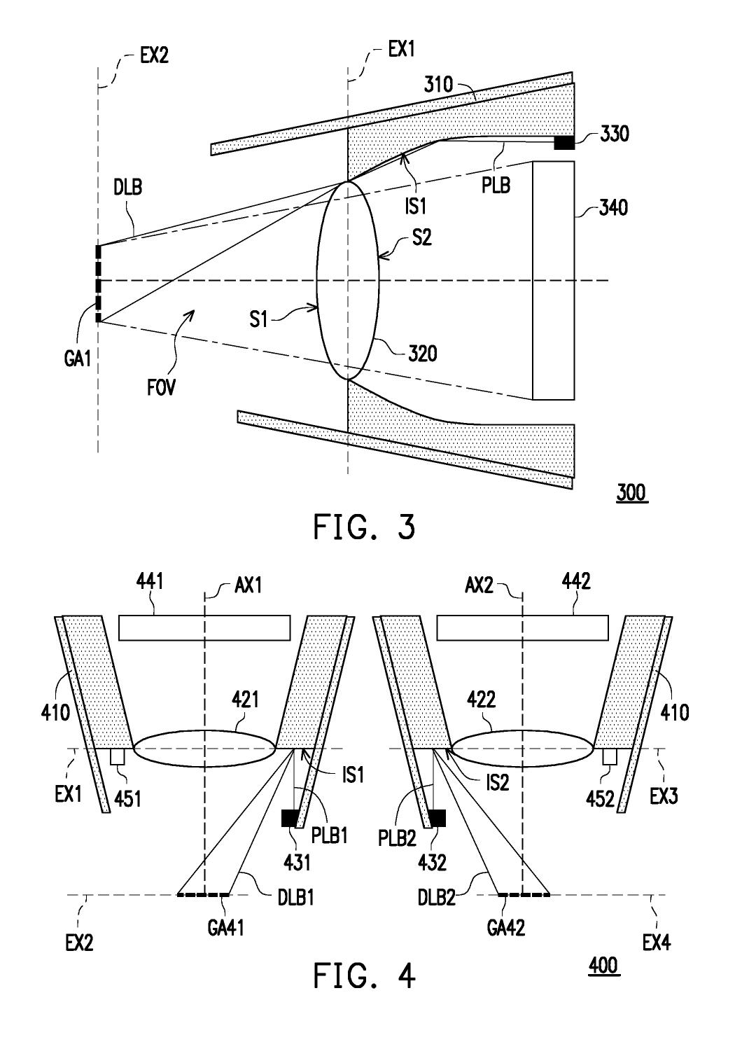

Referring to FIG. 3, which is a schematic view depicting a head-mounted display apparatus in another embodiment of the invention. A head-mounted display apparatus 300 includes a shell 310, a lens device 320, a light emitter 330, and a display 340. Being different from the previous embodiments, in the present embodiment, the target region GA1 is disposed adjacent to the first side S1 of the lens device 320, the light emitter 330 is disposed adjacent to the second side S2 of the lens device 320. The first side S1 of the lens device 320 and the second side S2 of the lens device 320 are opposite to each other. In other words, the light emitter 330 is disposed on the shell 310 outside of the axis EX1 of the lens device 320 and the axis EX2 of the target region GA1, and is disposed outside of the field of view FOV formed between the target region GA1 and the display 340.

The light emitter 130 transmits a projection light beam PLB and causes the projection light beam PLB to bring out at least one reflection action and scattering action according to the inner surface IS1 of the shell 310 to generate the detection light DLB. The detection light DLB is transmitted through the gap between the lens device 320 and the shell 310 to the target region GA1 and covers a pre-set area of the target region GA1.

Referring to FIG. 4, which is a schematic view depicting a head-mounted display apparatus in another embodiment of the invention. A head-mounted display apparatus 400 includes a shell 410, lens devices 421, 422, light emitters 431, 432, displays 441, 442, and image capturing devices 451, 452. The lens device 421 and the display 441 are disposed according to the axis AX1, and are configured to provide the user a first-eyed display image. The light emitter 431 is disposed on the shell 410 and is disposed adjacent to a target region GA41. The light emitter 431 transmits a projection light beam PLB1 and causes the projection light beam PLB1 to bring out at least one reflection action and scattering action according to the inner surface IS1 of the shell 410 to generate a detection light DLB1. The detection light DLB1 is projected to the target region GA41 and covers a pre-set area of the target region GA41.

On the other hand, the lens device 422 and the display 442 are disposed according to the axis AX2, and are configured to provide the user a second-eyed display image. The light emitter 432 is disposed on the shell 410 and is disposed adjacent to the target region GA42. The light emitter 432 transmits a projection light beam PLB2 and causes the projection light beam PLB2 to bring out at least one reflection action and scattering action according to an inner surface IS2 of the shell 410 to generate a detection light DLB2. The detection light DLB2 is projected to the target region GA42 and covers a pre-set area of the target region GA42.

The lens device 421 and the lens device 422 are respectively disposed to extend along the axis EX1 and the axis EX3. The target region GA41 and the target region GA42 are respectively disposed to extend along the axis EX2 and the axis EX4. The axis EX1 and the axis EX3 may be coincident, parallel, transverse, or skew to each other. The axis EX2 and the axis EX4 may also be coincident, parallel, transverse, or skew to each other. The light emitter 431 may be disposed on the shell 410 between the axis EX1 and the axis EX2, or may be disposed on the shell 410 outside of the axis EX1 and the axis EX2. The light emitter 432 may be disposed on the shell 410 between the axis EX3 and the axis EX4, or may be disposed on the shell 410 outside of the axis EX3 and the axis EX4.

It is noteworthy that, in the embodiment of the invention, the head-mounted display apparatus 400 has image capturing devices 451, 452 disposed corresponding to the target regions GA41, GA42, respectively. The image capturing devices 451, 452 are configured to capture the images on the target regions GA41, GA42, respectively. When performing the eyeball tracking process, the image capturing devices 451, 452 can capture images generated on the target regions GA41,GA42 (the eyes of the user) according to the detection lights DLB1, DLB2, respectively. As a result, the head-mounted display apparatus 400 can obtain the images according to the image capturing devices 451, 452.

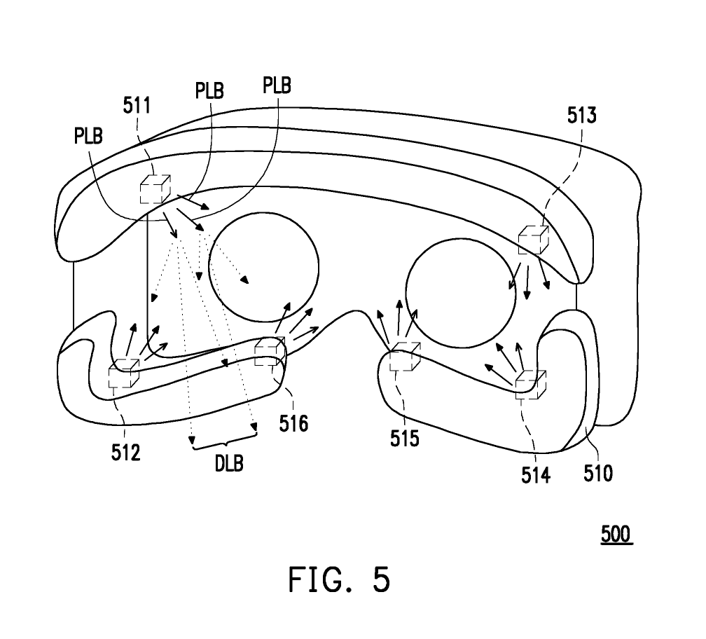

Referring to FIG. 5, which is a schematic structural view depicting a head-mounted display apparatus in an embodiment of the invention. The head-mounted display apparatus 500 has a shell 510. One or more light emitters 511 to 516 may be disposed on the shell 510. In FIG. 5, the light emitters 511 to 516 may be selected for disposition, and it is not necessary to dispose all of the light emitters. Take the light emitter 511 as an example, the light emitter 511 transmits the projection light beam PLB and causes the projection light beam PLB to bring out one or more times of the reflection action and scattering action on the inner surface of the shell 510 to generate the detection light DLB. The detection light DLB may be projected to the target region and covers a pre-set area on the target region.

Via the above-mentioned mechanism, the detection light DLB in the embodiments of the invention can be evenly projected onto the eyes of the user without generating stray light spots.

In summary, the invention causes the projection light beam to generate the detection light via one or more times of the reflection actions and scattering actions, and causes the projection surface of the detection light covers a pre-set area on the target region. As a result, when performing the eyeball tracking process, the detection light can evenly cover the eyes of the user, so as to reduce the influence possibly caused by the stray light spots.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A head-mounted display apparatus, comprising:
a shell, having an inner surface; and
a first light emitter, disposed on the shell, the first light emitter transmitting a first projection light beam to the inner surface of the shell and causing the first projection light beam to bring out at least one reflection action and a scattering action according to the inner surface to generate a first detection light,
wherein the first detection light is projected to a first target region, and a first projection surface of the first detection light covers a first pre-set area of the first target region.

2. The head-mounted display apparatus as recited in claim 1, further comprising:
a first lens device, disposed in the shell, extending along a first axis, and having a first side adjacent to the first target region; and
a first display, disposed in the shell and adjacent to a second side of the first lens device, wherein the first side of the first lens device is opposite to the second side of the first lens device,
wherein the first target region and the first display form a first field of view therebetween, and wherein the first target region extends along a second axis.

3. The head-mounted display apparatus as recited in claim 2, wherein the first light emitter is disposed between the first axis of the first lens device and the second axis of the first target region,
wherein the first light emitter is disposed outside of the first field of view.

4. The head-mounted display apparatus as recited in claim 2, wherein the first light emitter is disposed on the shell between the first axis of the first lens device and the second axis of the first target region.

5. The head-mounted display apparatus as recited in claim 2, wherein the first light emitter is disposed on the shell outside of the first axis of the first lens device and the second axis of the first target region.

6. The head-mounted display apparatus as recited in claim 1, further comprising:
an image capturing device, disposed on the shell and configured to capture an image on the first target region.

7. The head-mounted display apparatus as recited in claim 1, further comprising:
a second light emitter, disposed on the shell, the second light emitter transmitting a second projection light beam to the inner surface of the shell and causing the second projection light beam to bring out at least one reflection action and a scattering action according to the inner surface to generate a second detection light,
wherein the second detection light is projected to a second target region, and a second projection surface of the second detection light covers a second pre-set area of the second target region.

8. The head-mounted display apparatus as recited in claim 7, further comprising:
a second lens device, disposed in the shell, extending along a third axis, and having a first side adjacent to the second target region; and
a second display, disposed in the shell and adjacent to a second side of the second lens device, wherein the first side of the second lens device is opposite to the second side of the second lens device,
wherein the second target region and the second display form a second field of view therebetween, and wherein the second target region extends along a fourth axis.

9. The head-mounted display apparatus as recited in claim 7, wherein the second light emitter is disposed between the third axis of the second lens device and the fourth axis of the second target region,
wherein the second light emitter is disposed outside of the second field of view.

10. The head-mounted display apparatus as recited in claim 7, wherein the second light emitter is disposed on the shell between the third axis of the second lens device and the fourth axis of the second target region.

11. The head-mounted display apparatus as recited in claim 7, wherein the second light emitter is disposed on the shell outside of the third axis of the second lens device and the fourth axis of the second target region.

12. The head-mounted display apparatus as recited in claim 7, further comprising:
an image capturing device, disposed on the shell and configured to capture an image on the second target region.
